(19) United States
(12) Patent Application Publication
(10) Pub. No.: US 2004/0112709 A1
(43) Pub. Date: Jun. 17, 2004

(54) Coin-operated cabinet lock

(76) Inventor: Ping Jan Yang, Hsinchuang City (TW)

Correspondence Address: PING JAN YANG, 8F-9, NO. 1, WU CHUAN I RD., HSINCHUANG CITY, TAIPEI HSIEN, TW

(21) Appl. No.: 10/320,117

(22) Filed: Dec. 12, 2002

(51) Int. Cl. G06M 1/28; G06M 3/10; G07F 9/08

(52) U.S. Cl. 194/227

(57) ABSTRACT

A coin-operated cabinet lock is constructed to include a casing having a coin slot and a coin return, an adjustment unit adapted to adjust the opening of the coin slot to fit one of a set of coins, a track unit provided inside the casing and adapted to guide an inserted coin from the coin slot to the coin return, a back cover covering the casing, and a locking mechanism installed in the back cover with the keyway of the lock cylinder exposed to the outside of the cabinet for receiving the key.

### BACKGROUND OF THE INVENTION

1. Field of the Invention

The present invention relates to a coin-operated lock and, more particularly, to a coin-operated cabinet lock for use to lock a cabinet, which is kept inside the cabinet with the keyway exposed to the outside of the cabinet for receiving the key when installed and, which can be controlled to adjust the opening of the coin slot subject to a specific coin.

2. Description of the Related Art

When a conventional coin-operated cabinet lock installed in a cabinet, it is provided at the outside of the cabinet. Because this design of coin-operated cabinet lock is exposed to the outside of the cabinet, an external object can easily be inserted into the coin slot to damage the lock. For example, people may intentionally insert a nail, iron plate, chewing gum, or any of a variety of objects to block the passage of the coin slot. Further, the opening of the coin slot of a conventional coin-operated cabinet lock is specifically designed to fit a specific coin. Because the opening of the coin slot is not adjustable, different coin-operated cabinet locks should be prepared to fit different coins. This drawback greatly increases the manufacturer's inventory cost and manufacturing cost.

Therefore, it is desirable to provide a coin-operated cabinet lock that eliminates the aforesaid drawbacks.

### SUMMARY OF THE INVENTION

The present invention has been accomplished under the circumstances in view. It is the main object of the present invention to provide a coin-operated cabinet lock, which fits any of a variety of coins. It is another object of the present invention to provide a coin-operated cabinet lock, which is hidden inside the cabinet when installed, preventing the insertion of an external object into the coin slot to damage the internal parts. To achieve these and other objects of the present invention, the coin-operated cabinet lock comprises a casing having a coin slot and a coin return, an adjustment unit adapted to adjust the opening of the coin slot to fit one of a set of coins, a track unit provided inside the casing and adapted to guide an inserted coin from the coin slot to the coin return, a back cover covering the casing, and a locking mechanism installed in the back cover with the keyway of the lock cylinder exposed to the outside of the cabinet for receiving the key.

### BRIEF DESCRIPTION OF THE DRAWINGS

FIG. 1 is an exploded view of a coin-operated cabinet lock according to the present invention.

FIG. 2 is a plain view of the coin-operated cabinet lock according to the present invention.

FIG. 3 is a schematic drawing of the present invention, showing the adjustment of the adjustment unit.

FIG. 4 is a schematic plain view of the present invention showing the locking plate rotated before insertion of a coin.

FIG. 5 is a schematic drawing showing the action of the coin-operated cabinet lock after insertion of a coin (I).

FIG. 6 is a schematic drawing showing the action of the coin-operated cabinet lock after insertion of a coin (II).

FIG. 7 is a schematic drawing showing the action of the coin-operated cabinet lock after insertion of a coin (III).

FIG. 8 is a schematic drawing showing the action of the coin-operated cabinet lock after insertion of a coin (IV).

FIG. 9 is a plain view of the present invention showing the arrangement of the coin return structure of the coin-operated cabinet lock.

FIG. 10 is a schematic drawing of the present invention showing the coin return action of the coin-operated cabinet lock.

FIG. 11 is a perspective view showing the coin-operated cabinet lock installed in a cabinet.

### DETAILED DESCRIPTION OF THE PREFERRED EMBODIMENTS

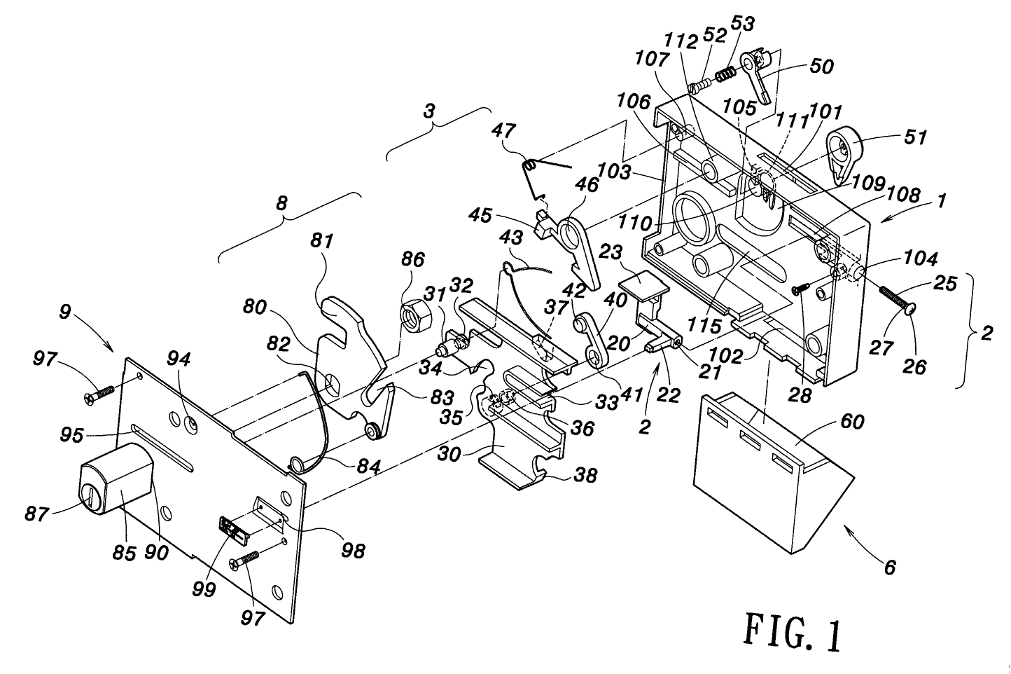

Referring to FIGS. 1˜11, a coin-operated cabinet lock is shown comprised of a casing 1, an adjustment unit 2, a track unit 3, a back cover 9, a locking mechanism 8, and a coin box 6.

Referring to FIGS. 1˜3, the casing 1 is substantially shaped like a rectangular box, comprising a coin slot 101 in the top side, a first guide block 105 disposed on the inside below the coin slot 101, a sector recess 109 adjacent the guide block 105, a small hole 110 in the sector recess 109, a flange 111 protruded from the front face around the small hole 110, a coin return handle 51 fastened pivotally with the flange 111, a coin return arm 50 fastened pivotally with the flange 111 and connected to the coin return handle 51 with a screw 52 and a spring 53 on the screw 52, a coin return 102 in the bottom side, a transverse sliding slot 115 spaced between the sector recess 109 and the coin return 102, a side notch 103 in one lateral side, a stub rod 107 disposed on the inside adjacent to the top end of the side notch 103, a second guide block 106 adjacent to the side notch 103 below the stub rod 107, a support 112 spaced above the second guide block 106, a side hole 104 in one lateral side opposite to the side notch 103, and a sliding groove 108 inwardly extended from the side hole 104.

The adjustment unit 2 comprises an adjustment block 20, an adjustment screw 25, and a holding down screw 28. The adjustment block 20 is movably mounted in the sliding groove 108, having a screw hole 21 and an index finger 22 at one end and a damper 23 at the other end. The damper 23 is adapted to control the opening of the coin slot 101, and define with the first guide block 105 a coin path. The adjustment screw 25 is inserted through the side hole 104 of the casing 1 and threaded into the screw hole 21 of the adjustment block 20, having an annular groove 27 extended around the periphery of the threaded shank near the slotted head 26. The holding down screw 28 is fastened to the casing 1 and perpendicularly engaged into the annular groove 27 of the adjustment screw 25 to stop the adjustment screw 25 from axial movement. Therefore, rotating the adjustment screw 25 clockwise/counter-clockwise causes the adjustment block 20 to be moved forwards/backwards along the sliding groove 108 (see FIGS. 1 and 3) to further adjust the opening of the coin slot 101 and the width of the coin path defined between the damper 23 and the first guide block 105.

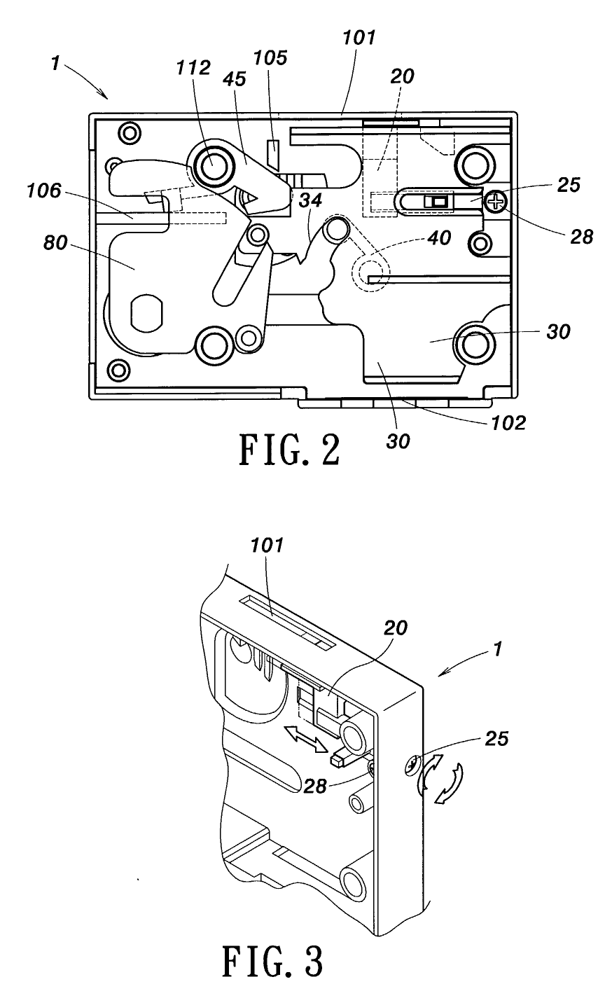

The track unit 3 is comprised of a sliding plate 30, a swivel member 40, an actuating member 45, a first spring member 43, and a second spring member 47. The actuating member 45 has a pivot hole 46 coupled to the support 112 of the casing 1. The second spring member 47 is a torsional spring mounted on the stub rod 107 of the casing 1, having one end hooked in one end of the actuating member 45 and the other end stopped against a part inside the casing 1. The second spring member 47 imparts a pressure to one end of the actuating member 45, causing the other end (the hooked outer end) of the actuating member 45 to be extended over the first guide block 105. The sliding plate 30 is provided above the actuating member 45 and the adjustment block 20, having two round rods 31 and 32 respectively protruded from the front and back sides in one lateral side (the left side near the actuating member 45), an elongated slot 33 at the other lateral side (the right side) remote from the round rods 31 and 32 for the passing of the index finger 22, an arched opening 34 adjacent to the round rods 31 and 32, a slide block 35 disposed adjacent to the arched opening 34 and movably coupled to the transverse sliding slot 115 of the casing 1, a pivot rod 36 spaced between the slide block 35 and the elongated slot 33, an oblique wedge 37 protruded from the back side and spaced above the arched opening 34, and a stop flange 38 at the bottom side. The swivel member 40 has a pivot hole 41 formed in one end and coupled to the pivot rod 36 of the sliding plate 30, and a protruding rod 42 perpendicularly extended from the other end and coupled to the arched opening 34 of the sliding plate 30. The first spring member 43 is mounted on one round rod 32 of the sliding plate 30, having one end fixedly fastened to the slide block 35 and the other end stopped against the protruding rod 42. The first spring member 43 supports the swivel member 40 in the topmost side of the arched opening 34 when no coin is inserted (see FIG. 2).

The back cover 9 is a thin sheet member covered on the back side of the casing 1 and fixedly secured thereto with screws 97, having a lock hole 90, a small hole 94 near the top side, a narrow elongated slot 95 extended in transverse direction between the small hole 94 and the lock hole 90 and adapted to receive one round rod 31 of the sliding plate 30, a view window 98 corresponding to the index finger 22 for enabling the user to visually check the position of the index finger 22, and a mark label 99 adhered to the view window 98 to indicate the position of the index finger 22. Further, marks may be directly marked or printed on the view window 98 instead of the mark label 99.

The locking mechanism 8 comprises a locking plate 80, a lock cylinder 85, a spring 84, and a lock nut 86. The locking plate 80 has a hook 81 a hole 82 below the hook 81, and an opening 83 remote from the hook 81. The spring 84 is mounted on the locking plate 80, having one end fastened to the small hole 94 of the back cover 9. The lock cylinder 85 is mounted in the lock hole 90 of the back cover 9 and inserted through the hole 82 of the locking plate 80. The lock nut 86 is fastened to the lock cylinder 85 and stopped against the back side of the locking plate 80 to secure the locking plate 80 to the lock cylinder 85. The lock cylinder 85 has a keyway 87.

The coin box 6 is sandwiched in between the casing 1 and the back cover 9, having a receiving chamber 60 suspended below the coin return 102.

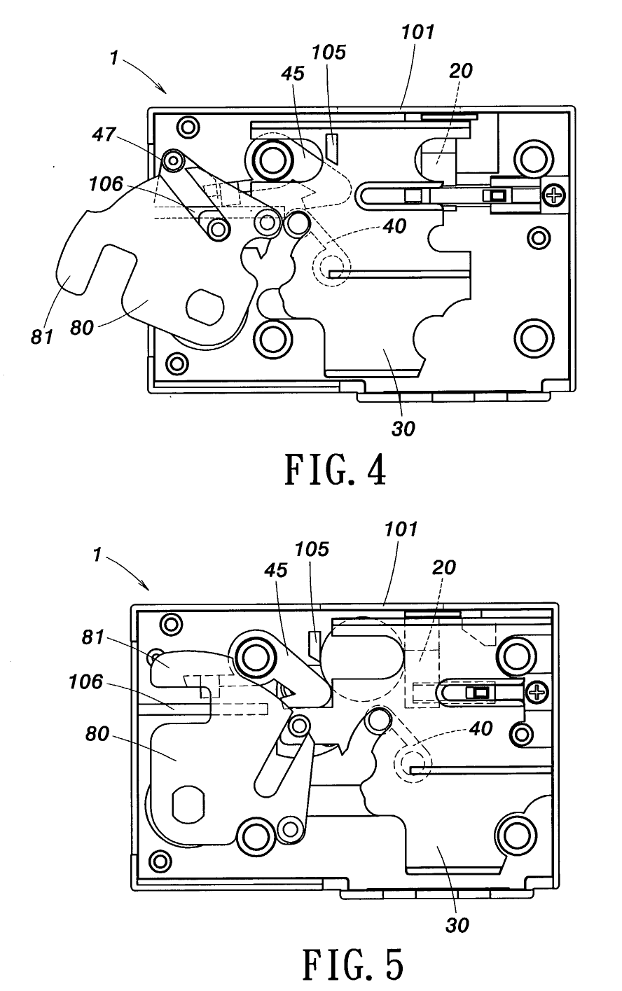

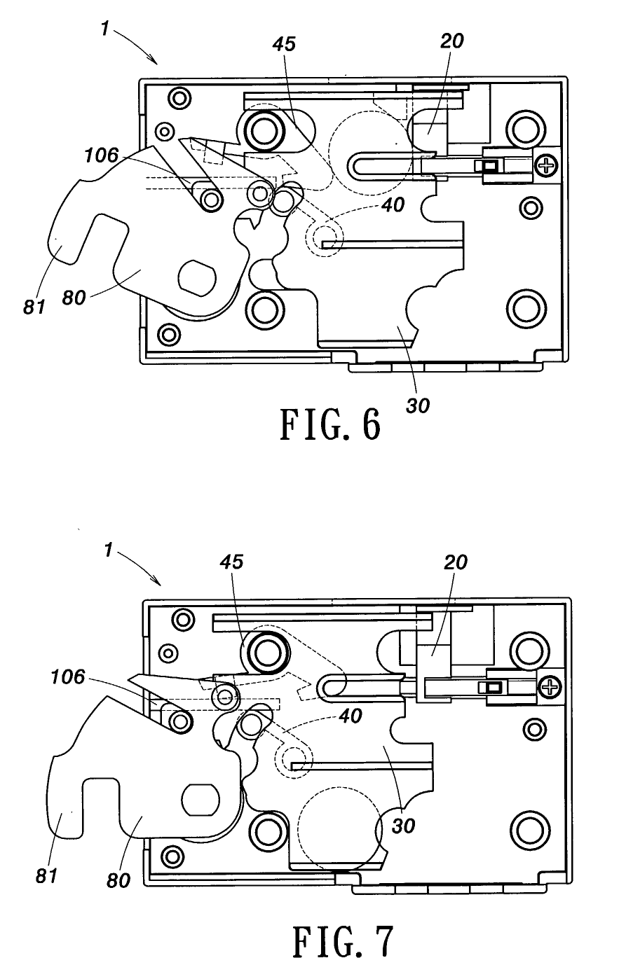

With reference to FIG. 4, when no coin is inserted, the actuating member 45 is supported on the second spring member 47 of the track unit 3 and extended over the first guide block 105 without touching the second guide block 106. When rotating the locking plate 80 at this time, the swivel member 40 touches the second guide block 106 to limit the angle of rotation of the locking plate 80, and therefore the locking plate 80 cannot be turned to the locking position with the hook 81 perpendicularly aimed at the ground.

With reference to FIGS. 5˜7, when a coin inserted into the coin slot 101, it moves along the coin path between the first guide block 105 and the adjustment block 20 to touch the actuating member 45, thereby causing the actuating member to touch the second guide block 106. When rotating the locking plate 80 at this time, the swivel member 40 is moved along the bottom side of the hooked outer end of the actuating member 45 below the second guide block 106 without being hindered by the second guide block 106. Therefore, the swivel member 40 does not constrain the locking plate 80, and the hook 81 is turned with the locking plate 80 to the downwardly extended locking position, and at the same time, the inserted coil is moved downwards.

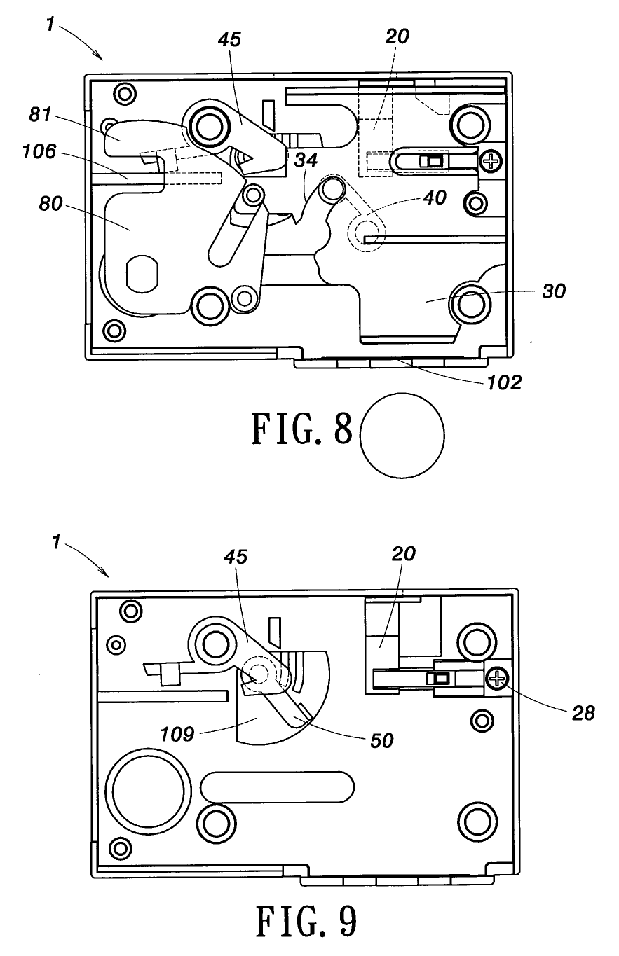

With reference to FIG. 8 and FIG. 11, when the user inserted the key into the keyway 87 of the lock cylinder 85 to rotate the locking plate 80 in the reversed direction from the locking position to the unlocking position and to open the cabinet 5, the swivel member 40 and the slide plate 30 are respectively returned to their former positions (see FIG. 2). When the sliding plate 30 returned to its former position, the inserted coil moves out of the coin return 102.

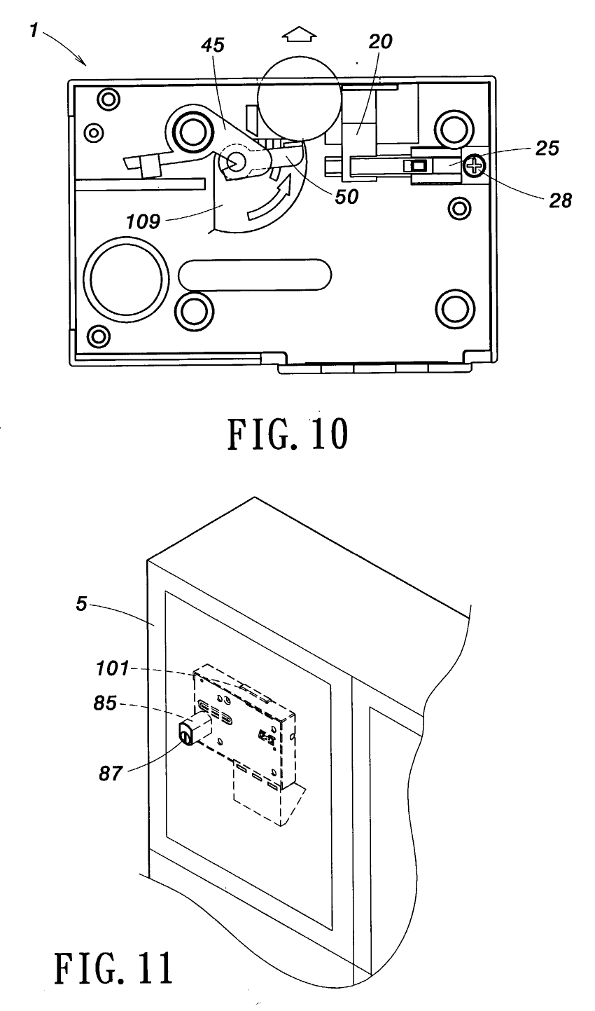

With reference to FIGS. 9 and 10 and FIG. 1, if the inserted coin jammed inside the cabinet, rotate the coin return handle 51 to move the coin return arm 50, causing the coin return arm 50 to push the inserted coin out of the coin slot 101.

With reference to FIG. 11 and FIG. 1, the keyway 87 of the lock cylinder 85 is exposed to the outside of the cabinet 5, the coin slot 101 and the coin return handle 5 as well as the adjustment unit 2 are disposed inside the cabinet 5 and kept from sight when the cabinet 5 closed. This design prevents insertion of an external object into the inside of the cabinet 5 either intentionally or accidentally.

As indicated above, the coin-operated cabinet lock has an adjustment unit through which the user can adjust the opening of the coin slot to fit any of a variety of coins. Further, because the coin slot is provided inside the cabinet, it is well protected against the damage of an external object. Therefore, the maintenance cost of the coin-operated cabinet lock is low.

A prototype of coin-operated cabinet lock has been constructed with the features of FIGS. 1˜11. The coin-operated cabinet lock functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A coin-operated cabinet lock comprising:
a casing substantially shaped like a rectangular box, said casing comprising a coin slot in a top side thereof, a transverse sliding groove disposed near one lateral side thereof, and a first guide block disposed on the inside adjacent to said coin slot;
an adjustment unit adapted to adjust the opening of said coin slot to fit one of a set of coins, said adjustment unit comprising an adjustment block adapted to move back and forth along said transverse sliding groove to adjust the opening of said coin slot, said adjustment block having a first end, a second end, a screw hole formed in said first end, an index finger perpendicularly extended from said first end, and a damper protruded from said second end toward said coin slot, an adjustment screw mounted in one side of said casing and threaded into the screw hole of said adjustment block, and a holding down screw mounted in said casing and perpendicularly stopped against said adjustment screw top stop said adjustment screw from axial movement and for enabling said adjustment screw to be rotated to move said adjustment block along said sliding groove;
a track unit, said track unit being comprised of a sliding plate, a swivel member, an actuating member, a first spring member, and a second spring member, said actuating member fastened pivotally with said casing and having a hooked first end suspended adjacent to said coin slot and a second end supported on said second spring member near one lateral side of said casing, said swivel member being pivoted to said sliding plate and supported on said first spring member at said sliding plate, said sliding plate being disposed above said actuating member and said adjustment block, said sliding plate having an oblique wedge, which defines with said first guide block a coin track;
a thin sheet back cover covered on said casing;
locking mechanism, said locking mechanism comprising a lock cylinder mounted in said back cover, a locking plate to be turned by said lock cylinder between a locking position and an unlocking position, and a spring mounted on said locking plate and connected to said back cover to support said locking plate in the unlocking position; and
a coin box sandwiched in between said casing and said back cover below said coin return; and
wherein rotating said adjustment screw causes said adjustment block to be moved along said transverse sliding groove to adjust the opening of said coin slot and the width of the coin track defined between said oblique wedge and said first guide block.

2. The coin-operated cabinet lock as claimed in claim 1 wherein said back cover has a view window for viewing the position of said index finger of said adjustment block.

3. The coin-operated cabinet lock as claimed in claim 2 wherein said view window is marked with marks for indicating the position of said index finger of said adjustment block.
